(19) United States
(12) Patent Application Publication
(10) Pub. No.: US 2020/0013242 A1
(43) Pub. Date: Jan. 9, 2020

(54) SENSOR FAILURE DETECTION DEVICE AND CONTROL METHOD FOR SAME

(71) Applicant: Panasonic Intellectual Property Management Co., Ltd., Osaka (JP)

(72) Inventor: DAIKI HAMADA, Tokyo (JP)

(21) Appl. No.: 16/321,614

(22) PCT Filed: Jul. 21, 2017
(86) PCT No.: PCT/JP2017/026419

§ 371 Date: Jan. 29, 2019

(30) Foreign Application Priority Data
Sep. 29, 2016 (JP) 2016-191992

(51) Int. Cl. G07C 5/08; G01S 7/40; G01S 7/497; G01S 7/52; B60Q 9/00

(52) U.S. Cl. CPC G07C 5/085; G01S 7/40; B60Q 9/008; G01S 7/52004; G01S 7/497

(57) ABSTRACT

A sensor failure detection device includes an input circuit and an output circuit and is installable on a vehicle. The input circuit is configured to connect with a sensor disposed on the vehicle and to receive reference information and location information on the vehicle. When a predetermined relation is found among a detection result of the sensor, the reference information, and the location information that have been input to the input circuit, the output circuit outputs that the sensor has failed.

### TECHNICAL FIELD

The present invention relates to a failure detection technique, and, more particularly, to a sensor failure detection device that detects an occurrence of a failure of a sensor and a control method for the sensor failure detection device.

### BACKGROUND ART

For autonomous driving of a vehicle, an on-vehicle sensor is typically used. Such an on-vehicle sensor needs to undergo, before the start of autonomous driving, determination of whether the sensor is ready for use in autonomous driving. To that end, for example, determination is made whether autonomous driving is enabled based on a comparison between a relative travel history of autonomous navigation under which a point where a marker embedded in a road surface is detected as a starting point and lane shape point information acquired from the latest map data (for example, refer to PTL 1).

### CITATION LIST

### Patent Literature

PTL 1: Unexamined Japanese Patent Publication No. 2015-162175

### SUMMARY OF THE INVENTION

The present invention provides a technique for easily detecting an occurrence of a failure of a sensor.

An aspect of the present invention is a sensor failure detection device that is installable on a vehicle, and includes an input circuit and an output circuit. The input circuit is configured to connect with a sensor disposed on the vehicle and to receive reference information and location information on the vehicle. When a predetermined relation is found among a detection result of the sensor, the reference information, and the location information that have been input to the input circuit, the output circuit outputs that the sensor has failed.

Any combinations of the above-described components and modifications of the features of the present invention in methods, devices, systems, recording media (including non-transitory recording media), and computer programs are still effective as other aspects of the present invention.

The present invention allows, even under a condition where a plurality of sensors are in use, the occurrence of a failure to be easily detected for each of the sensors.

### BRIEF DESCRIPTION OF DRAWINGS

FIG. 1 is a diagram showing a configuration of a vehicle according to a first exemplary embodiment of the present invention.

FIG. 2 is a diagram showing an outline of failure detection processing performed by a failure detection device shown in FIG. 1.

FIG. 3 is a flowchart showing a processing procedure of failure detection performed by the failure detection device shown in FIG. 1.

FIG. 4 is a flowchart showing another processing procedure of the failure detection performed by the failure detection device shown in FIG. 1.

FIG. 5 is a flowchart showing yet another processing procedure of the failure detection performed by the failure detection device shown in FIG. 1.

FIG. 6 is a flowchart showing yet another processing procedure of the failure detection performed by the failure detection device shown in FIG. 1.

FIG. 7 is a diagram showing a configuration of a detector according to a second exemplary embodiment of the present invention.

FIG. 8 is a diagram showing an outline of failure detection processing performed by the detector shown in FIG. 7.

FIG. 9 is a flowchart showing a processing procedure of failure detection performed by a failure detection device according to the second exemplary embodiment of the present invention.

### DESCRIPTION OF EMBODIMENTS

Prior to describing exemplary embodiments of the present invention, problems found in a conventional technique will be briefly described. A plurality of sensors of various types are mounted at various places on a vehicle. It is thus desirable to individually detect whether the sensors have failed. Further, it is desirable to eliminate the need for additional expenditures on facilities, such as markers embedded in a road surface, for detection of a sensor failure.

### First exemplary embodiment

Prior to specifically describing an exemplary embodiment of the present invention, an outline of the exemplary embodiment will be described. The first exemplary embodiment of the present invention relates to a failure detection device that detects a failure of a sensor mounted on a vehicle capable of autonomous driving. The sensor detects an object such as an obstacle present around the vehicle, and the vehicle autonomously travels while avoiding a collision with the object thus detected. That is, the vehicle capable of autonomous driving recognizes a surrounding situation of the vehicle based on a detection result of the sensor instead of human perception. The sensor may fail to detect a location of the object due to noise or the like or may output an abnormal value due to a failure. It is not desirable to use the detection result of such a sensor for autonomous driving. This requires detection that reliability of the detection result of the sensor is low or the sensor has failed.

On the other hand, a plurality of sensors are mounted on the vehicle, and the sensors thus mounted are of various types. Each of the sensors has a different object detectable range (hereinafter, referred to as “search range”). Note that the search range of a given sensor may overlap with the search range of another sensor. Hence, even when each of the sensors is working properly, the detection result of each of the sensors is different from the detection result of another sensor; thus, it is not desirable to compare the detection result of each of the sensors with the detection result of another sensor to detect that the reliability of the detection result of the sensor is low or the sensor has failed. Further, a plurality of sensors may be low in reliability or may fail. Accordingly, whether the reliability of the detection result of the sensor is low or the sensor has failed needs to be detected for each of the sensors.

To deal with the necessity, in the present exemplary embodiment, location information on an object (for example, a traffic light) whose installation location is known in advance and information on a type of the object (hereinafter, collectively referred to as “reference information”) are included in map information. The failure detection device acquires the reference information from the map information and compares the detection result of the sensor with the reference information to detect that reliability of the sensor is low or the sensor has failed. Note that the reference information may be included in a signal received by road-to-vehicle communication, rather than the map information. Further, a past detection result may be used as the reference information.

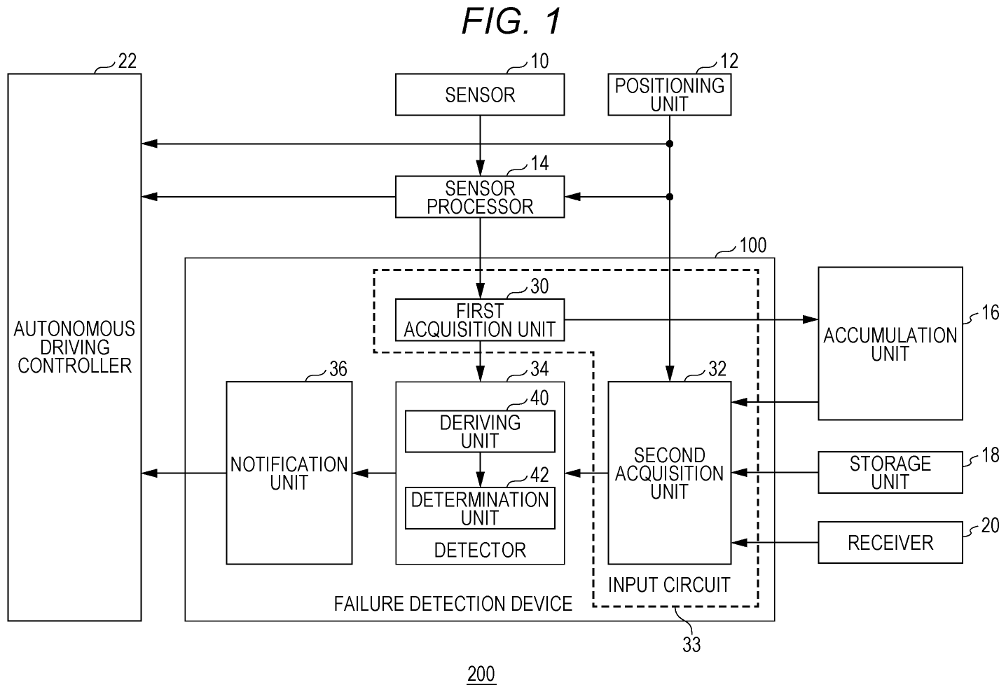

FIG. 1 shows a configuration of vehicle 200 according to the first exemplary embodiment of the present invention. Vehicle 200 includes sensor 10, positioning unit 12, sensor processor 14, accumulation unit 16, storage unit 18, receiver 20, autonomous driving controller 22, and failure detection device 100. Further, failure detection device (sensor failure detection device) 100 includes first acquisition unit 30, second acquisition unit 32, detector 34, and notification unit 36. Detector 34 includes deriving unit 40, and determination unit 42. Note that first acquisition unit 30 and second acquisition unit 32 may collectively serve as input circuit 33.

Examples of sensor 10 include a stereo camera (an image sensor of a camera device), a light detection and ranging or a laser imaging detection and ranging (LIDAR), a millimeter-wave radar, an ultrasonic sonar, and an infrared laser sensor. As described above, a plurality of sensors 10 are mounted on vehicle 200, and the plurality of sensors 10 are of a plurality of types, but only one sensor 10 will be illustrated herein. Any publicly known technique is applicable to sensor 10, and therefore, a description of sensor 10 will be omitted herein. Sensor 10 outputs a measurement result to sensor processor 14.

Positioning unit 12 measures a location, speed, travel direction, and the like of vehicle 200. The location is represented by a latitude and a longitude. Positioning unit 12 is, for example, a global navigation satellite system (GNSS) receiver, but may be a device for autonomous navigation such as a gyroscope sensor or a combination of such devices. Positioning unit 12 outputs the location, speed, travel direction, and the like thus measured (hereinafter, collectively referred to as “location information”) to sensor processor 14, autonomous driving controller 22, and second acquisition unit 32.

Sensor processor 14 receives the measurement result from sensor 10 and receives the location information from positioning unit 12. Sensor processor 14 specifies, based on the measurement result and the location information, a location where an object detected by sensor 10 is present. For example, sensor processor 14 specifies, based on the measurement result from sensor 10, the location of the object relative to vehicle 200 in the travel direction. Further, sensor processor 14 converts, based on the location and the travel direction included in the location information, the relative location of the object to a location represented by a latitude and a longitude.

Further, sensor processor 14 may specify a type of the object based on the detection result. For example, sensor processor 14 prestores information on shapes of objects of a plurality of types, and selects one from among the shapes that is the most similar to a shape indicated by the measurement result. Furthermore, sensor processor 14 specifies an object associated with the shape thus selected. Sensor processor 14 outputs, as a detection result, information on the location and type of the object to autonomous driving controller 22 and first acquisition unit 30.

First acquisition unit 30 acquires the detection result from sensor processor 14, that is, the detection result of sensor 10. That is, first acquisition unit 30 of input circuit 33 is configured to connect with sensor 10 disposed on vehicle 200 and to receive the reference information. First acquisition unit 30 outputs the detection result to accumulation unit 16 and detector 34. Accumulation unit 16 receives the detection result from first acquisition unit 30 and accumulates the detection result. That is, accumulation unit 16 accumulates a detection result previously acquired by first acquisition unit 30. Storage unit 18 stores map information such as map information used in an advanced driving assistant system (ADAS). The map information includes the reference information. The reference information includes at least a type of an object and location information indicating where the object is placed. That is, storage unit 18 stores a type of an object and location information indicating where the object is placed. Receiver 20 is capable of road-to-vehicle communication and vehicle-to-vehicle communication, and receives a signal from a roadside unit or an on-vehicle device (not shown). Herein, for example, receiver 20 receives a signal from a roadside unit. The roadside unit is installed on, for example, a traffic light, the signal from the roadside unit includes information on a location where the roadside unit is disposed, that is, a location where the traffic light is installed. This information corresponds to “reference information”.

Second acquisition unit 32 receives the location information from positioning unit 12. Second acquisition unit 32 checks whether at least one of accumulation unit 16, storage unit 18, and receiver 20 has reference information present in a vicinity of the location information. The vicinity is defined as a range almost the same as the object detectable range of sensor 10 (hereinafter, referred to as “searching range”). Note that a size of the searching range may be different for each type of sensor 10. Second acquisition unit 32 acquires, when reference information within the vicinity has been accumulated in accumulation unit 16, the reference information from accumulation unit 16. Further, second acquisition unit 32 acquires, when reference information within the vicinity has been stored in storage unit 18, the reference information from storage unit 18. Furthermore, second acquisition unit 32 acquires, when reference information within the vicinity has been received by receiver 20, the reference information from receiver 20. Such reference information is information to be compared with the detection result acquired by first acquisition unit 30. Second acquisition unit 32 outputs the reference information to detector 34.

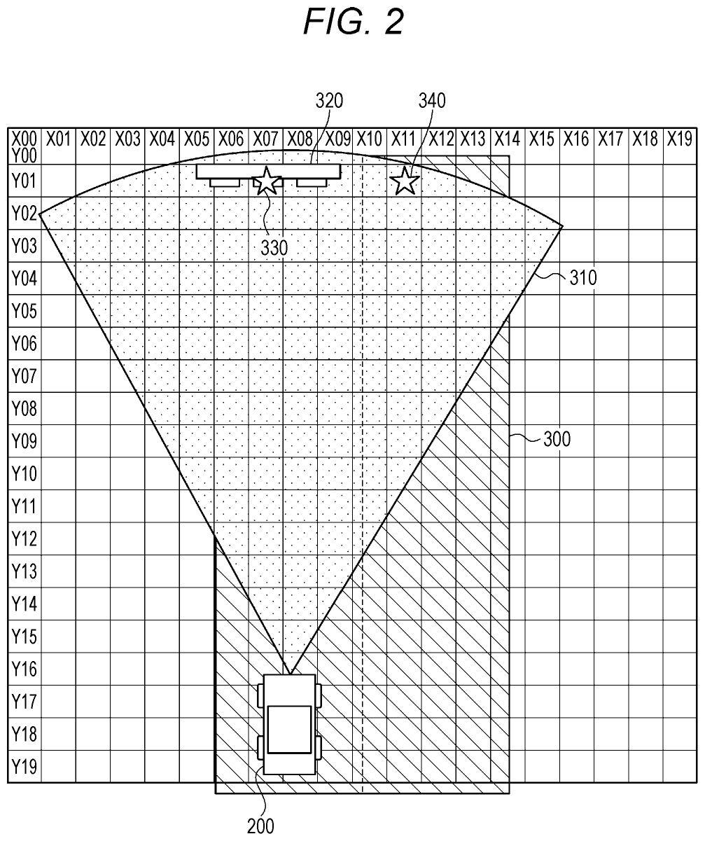

Detector 34 receives the detection result from first acquisition unit 30 and receives the reference information from second acquisition unit 32. Detector 34 detects, based on the reference information and the detection result, an occurrence of a failure of sensor 10. Herein, with reference to FIG. 2, this processing will be specifically described. FIG. 2 shows an outline of failure detection processing performed by failure detection device 100. The outline shows a case where vehicle 200 is traveling on road 300 in an upward direction of FIG. 2. Further, in order to detect an object present in the travel direction of vehicle 200, sensor 10 (not shown) is disposed on a front side of vehicle 200. Sensor 10 is capable of detecting an object disposed within detection range 310, and the above-described vicinity is defined as including detection range 310.

As shown in FIG. 2, a plurality of areas are defined as having the same size such that the areas do not overlap with each other. For example, one of the areas is represented by “X01-Y01”. A size of each of the areas is set to a size that allows a measurement error of sensor 10. That is, the size of each of the areas is defined as measurement accuracy of sensor 10. Herein, the size of each of the areas may be different for each type of sensor 10.

In such a configuration, within detection range 310, traffic light 320 is installed as an object. A location where traffic light 320 is installed is indicated by reference information 330. Herein, reference information 330 indicates range “X07-Y01”. On the other hand, detection result 340 of sensor 10 that has detected traffic light 320 indicates range “X11-Y01”, which is different from reference information 330. Return to FIG. 1.

Deriving unit 40 of detector 34 checks whether an area indicated by reference information 330 and an area indicated by detection result 340 match each other. A case where the areas match each other corresponds to a case where reference information 330 and detection result 340 match each other within a margin of error. Deriving unit 40 increases, when the areas match each other, reliability of sensor 10. On the other hand, deriving unit 40 decreases, when the areas do not match each other, the reliability of sensor 10. For example, the reliability is increased by “+1” and decreased by “−1”. As described above, deriving unit 40 derives, based on reference information 330 and detection result 340, the reliability of sensor 10.

Determination unit 42 determines that sensor 10 has failed when the reliability derived by deriving unit 40 is less than a threshold. On the other hand, determination unit 42 determines that sensor 10 is working properly when the reliability is greater than or equal to the threshold. Determination unit 42 outputs, to notification unit 36, that sensor 10 has failed or is working properly. Note that, it is only necessary that the processing of deriving unit 40 and the processing of detector 34 are performed only once for each traffic light 320, using reference information 330 in one of accumulation unit 16, storage unit 18, and receiver 20. Further, the processing of deriving unit 40 and the processing of detector 34 may be performed three times for each traffic light 320, using, for each time, a corresponding one of reference information 330 in accumulation unit 16, reference information 330 in storage unit 18, and reference information 330 in receiver 20.

Notification unit 36 notifies autonomous driving controller 22 of the occurrence of the failure detected by detector 34. That is, notification unit 36 outputs that sensor 10 has failed when a predetermined relation is found between the detection result of sensor 10 and the reference information that have been input to at least one of first acquisition unit 30 and second acquisition unit 32 of input circuit 33. Note that notification unit 36 may notify autonomous driving controller 22 of that sensor 10 is working properly. Notification unit 36 may further notify autonomous driving controller 22 of the reliability derived by deriving unit 40.

Autonomous driving controller 22 receives the location information from positioning unit 12 and receives the detection result from sensor processor 14. Autonomous driving controller 22 determines, based on the location information, a travel route of vehicle 200 on which a collision with the object indicated by the detection result is avoided. Autonomous driving controller 22 determines, upon being notified of that sensor 10 has failed from notification unit 36, the travel route of vehicle 200 without reflecting the detection result of sensor 10. Further, autonomous driving controller 22 may determine, when the reliability of sensor 10 notified from notification unit 36 is low, the travel route of vehicle 200 with an influence of the detection result of sensor 10 reduced. Any publicly known technique is applicable to the determination of the travel route of vehicle 200 made by autonomous driving controller 22, and therefore, a description of the determination will be omitted herein.

The above configuration can be implemented using a central processing unit (CPU), a memory, and other large-scale integration (LSI) of any given computer in terms of hardware and using a program loaded on the memory in terms of software. The drawings herein illustrate functional blocks achieved through coordination of these components. Hence, it will be understood by those skilled in the art that these functional blocks can be achieved in various forms by the hardware alone or by combinations of the hardware and the software.

Note that first acquisition unit 30, second acquisition unit 32, detector 34, and notification unit 36 of failure detection device 100 may be implemented as a first acquisition circuit, a second acquisition circuit, a detection circuit, and a notification circuit, respectively, all of which are hardware circuits. Further, first acquisition unit 30 and second acquisition unit 32 may be collectively implemented as input circuit 33 that is a hardware circuit. Further, notification unit 36 may be implemented as an output circuit that is a hardware circuit. Further, detector 34 may be implemented as a control circuit that is a hardware circuit. Further, receiver 20 may be implemented as a communication circuit that is a hardware circuit. Further, accumulation unit 16 may be implemented as an accumulation circuit that is a hardware circuit.

Input circuit 33 is configured to connect with sensor 10 disposed on vehicle 200 and to receive the reference information and the location information on the vehicle 200. Further, when the predetermined relation is found among the detection result of sensor 10, the reference information, and the location information that have been input to input circuit 33, the output circuit (notification unit 36) outputs that sensor 10 has failed. Input circuit 33 is configured to connect with positioning unit 12 disposed on vehicle 200 and to receive the location information on vehicle 200 from positioning unit 12.

When the predetermined relation is found among the detection result of sensor 10, the reference information, and the location information that have been input to input circuit 33, the control circuit (detector 34) performs control to cause the output circuit (notification unit 36) to output that the sensor has failed.

The control circuit (detector 34) includes a processor, and causes the processor to execute a predetermined program to perform control to cause the output circuit (notification unit 36) to output that sensor 10 has failed when the predetermined relation is found among the detection result of sensor 10, the reference information, and the location information that have been input to input circuit 33.

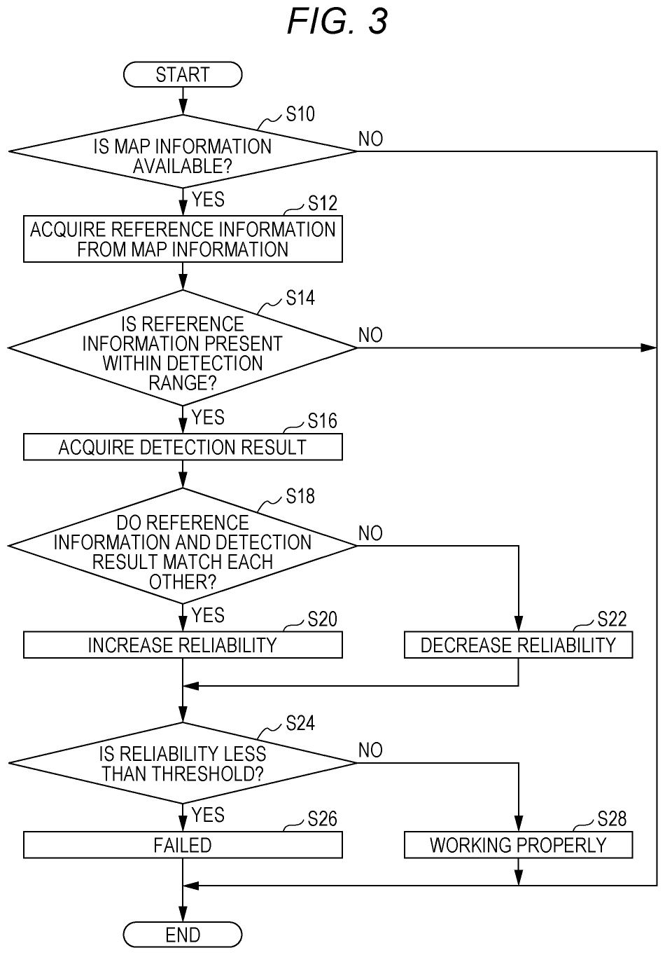

An operation of failure detection device 100 configured as described above will be described below. FIG. 3 is a flowchart showing a processing procedure of failure detection performed by failure detection device 100. Second acquisition unit 32 acquires the location information from positioning unit 12. Then, when the map information on a location indicated by the location information thus acquired is available (Y in S10), second acquisition unit 32 acquires, from the map information, reference information 330 within detection range 310 corresponding to the location information acquired (S12). When reference information 330 is present within detection range 310 (Y in S14), first acquisition unit 30 acquires detection result 340 (S16). When reference information 330 and detection result 340 match each other (Y in S18), deriving unit 40 increases the reliability (S20). When reference information 330 and detection result 340 do not match each other (N in S18), deriving unit 40 decreases the reliability (S22). When the reliability is less than the threshold (Y in S24), determination unit 42 determines that sensor 10 has failed (S26). When the reliability is not less than the threshold (N in S24), determination unit 42 determines that sensor 10 is working properly (S28). When the map information is not available (N in S10) or no reference information 330 is present within detection range 310 (N in S14), the processing is terminated.

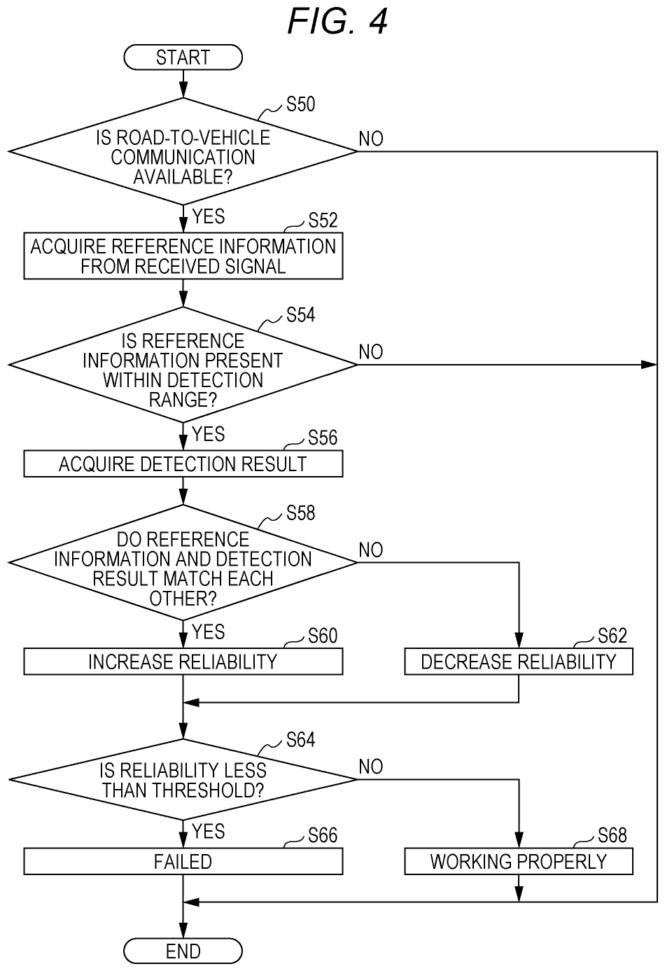

FIG. 4 is a flowchart showing another processing procedure of failure detection performed by failure detection device 100. When the road-to-vehicle communication is available (Y in S50), second acquisition unit 32 acquires reference information 330 from a received signal (S52). When reference information 330 is present within detection range 310 (Y in S54), first acquisition unit 30 acquires detection result 340 (S56). When reference information 330 and detection result 340 match each other (Y in S58), deriving unit 40 increases the reliability (S60). When reference information 330 and detection result 340 do not match each other (N in S58), deriving unit 40 decreases the reliability (S62). When the reliability is less than the threshold (Y in S64), determination unit 42 determines that sensor 10 has failed (S66). When the reliability is not less than the threshold (N in S64), determination unit 42 determines that sensor 10 is working properly (S68). When the road-to-vehicle communication is not available (N in S50) or no reference information 330 is present within detection range 310 (N in S54), the processing is terminated.

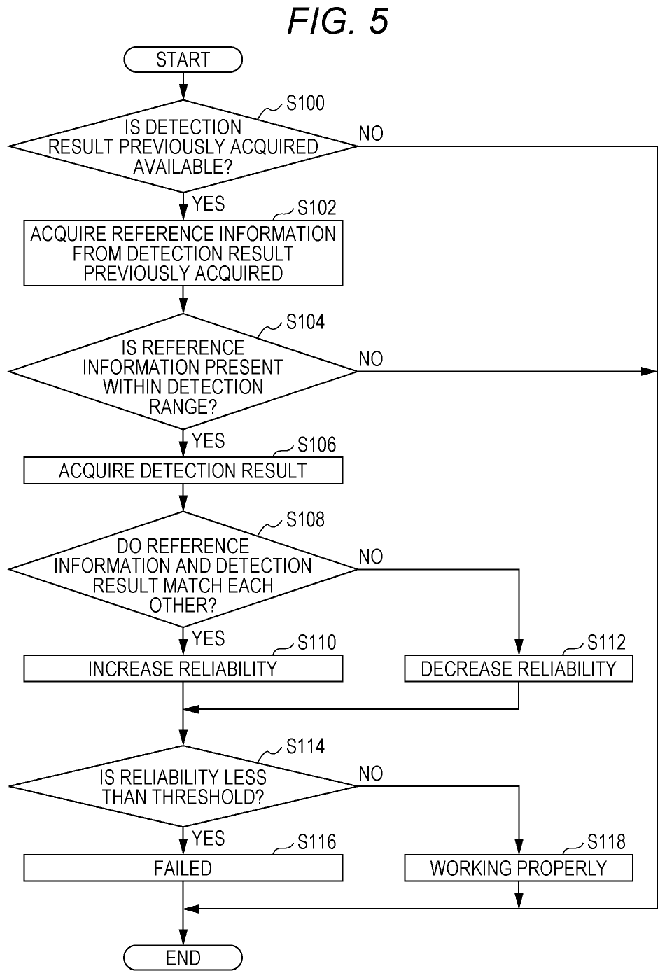

FIG. 5 is a flowchart showing yet another processing procedure of failure detection performed by failure detection device 100. When detection result 340 previously acquired is available (Y in S100), second acquisition unit 32 acquires reference information 330 from detection result 340 previously acquired (S102). When reference information 330 is present within detection range 310 (Y in S104), first acquisition unit 30 acquires detection result 340 (5106). When reference information 330 and detection result 340 match each other (Yin S108), deriving unit 40 increases the reliability (S110). When reference information 330 and detection result 340 do not match each other (N in S108), deriving unit 40 decreases the reliability (S112). When the reliability is less than the threshold (Y in S114), determination unit 42 determines that sensor 10 has failed (S116). When the reliability is not less than the threshold (N in S114), determination unit 42 determines that sensor 10 is working properly (S118). When detection result 340 previously acquired is not available (N in S100) or no reference information 330 is present within detection range 310 (N in S104), the processing is terminated.

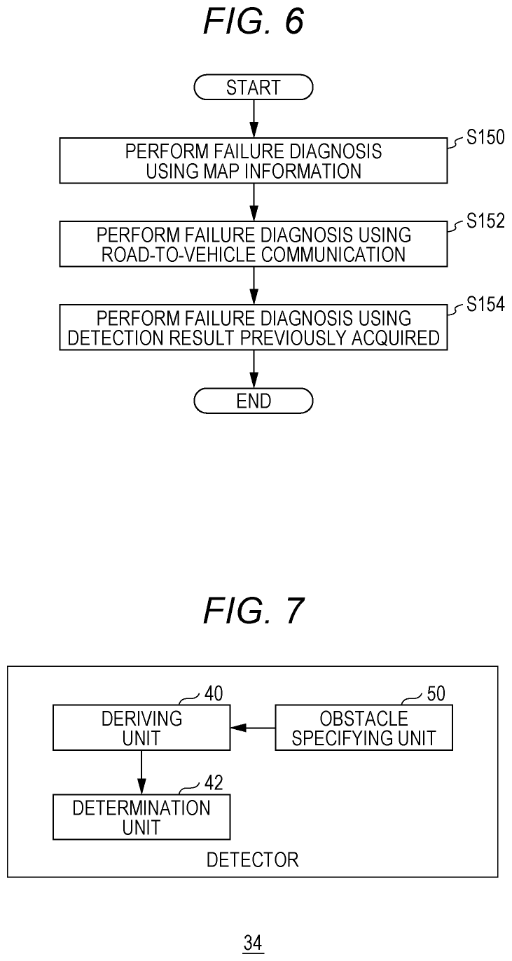

FIG. 6 is a flowchart showing yet another processing procedure of failure detection performed by failure detection device 100. Detector 34 performs a failure diagnosis using the map information (S150). Detector 34 performs a failure diagnosis using the road-to-vehicle communication (S152). Detector 34 performs a failure diagnosis using detection result 340 previously acquired (S154).

According to the present exemplary embodiment, the occurrence of the failure is notified based on the reference information and the detection result, which allows the processing to be performed for each sensor. Further, the processing is performed for each sensor, which allows the occurrence of the failure to be easily detected for each sensor. Further, the reference information included in the map information is prestored, which makes it possible to acquire the reference information through processing of only extracting the reference information from the storage unit. Further, the reference information is acquired through the processing of only extracting the reference information from the storage unit, which facilitates the acquisition of the reference information.

Further, the reference information is acquired from a received signal, which makes it possible to acquire the latest reference information even when the reference information has been updated. Further, the latest reference information is acquired even when the reference information has been updated, which makes it possible to deal with a case where the reference information is updated. Further, the detection result previously acquired is used as the reference information, which eliminates the need for preparing the reference information. Further, preparation of the reference information is not required, which facilitates a set-up of the failure detection device. Further, the determination of the occurrence of the failure is made based on the reliability that is adjusted based on the comparison between the reference information and the detection result, which makes it possible to improve determination accuracy. Further, autonomous driving controller 22 and the like is notified of the reliability, which makes it possible to achieve autonomous driving control and the like based on the reliability.

### Second Exemplary Embodiment

Next, a second exemplary embodiment will be described. The second exemplary embodiment relates to, similar to the first exemplary embodiment, a failure detection device that detects a failure of a sensor mounted on a vehicle capable of autonomous driving. The failure detection device according to the second exemplary embodiment acquires reference information from map information and compares a detection result of the sensor with the reference information to detect that reliability of the sensor is low or the sensor has failed. Here, when an obstacle is present between an object indicated by the reference information and the sensor, the object is not detected by the sensor. In the second exemplary embodiment, taking such a case into account, that the reliability of the sensor is low or the sensor has failed is detected. Failure detection device 100 according to the second exemplary embodiment is of the same type as shown in FIG. 1. Differences from the above description will be mainly described below.

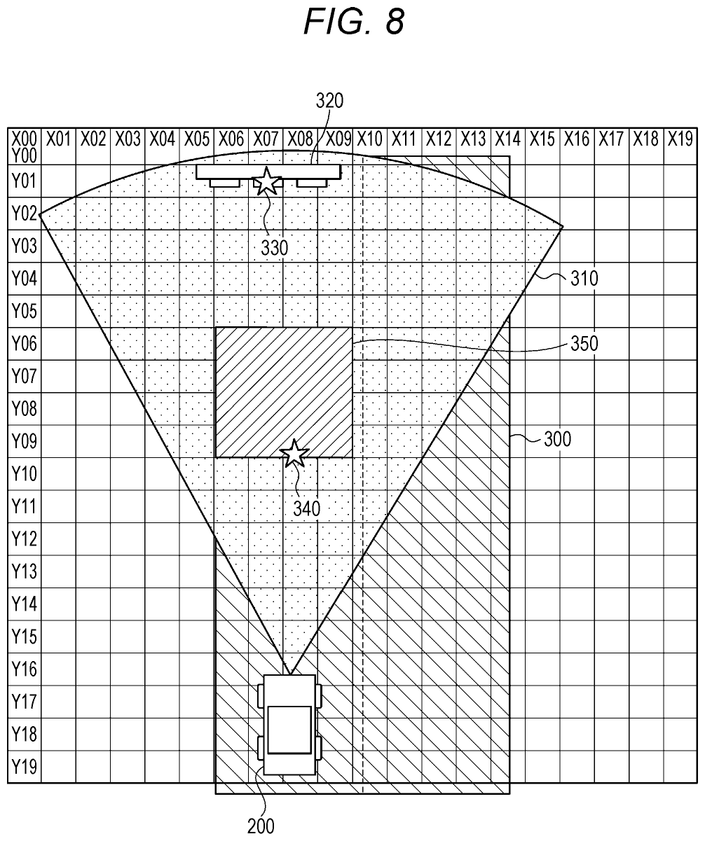

FIG. 7 shows a configuration of detector 34 according to the second exemplary embodiment of the present invention. Detector 34 includes deriving unit 40, determination unit 42, and obstacle specifying unit 50. Obstacle specifying unit 50 specifies whether the detection result acquired by first acquisition unit 30 indicates an object that is different from an object (for example, traffic light 320, or a roadside unit installed on traffic light 320) indicated by the reference information acquired by second acquisition unit 32. A description of processing performed by obstacle specifying unit 50 will be given here with reference to FIG. 8. FIG. 8 shows an outline of failure detection processing performed by detector 34. FIG. 8 is the same as FIG. 2 except that obstacle 350 is present between vehicle 200 and traffic light 320. Accordingly, detection result 340 from first acquisition unit 30 corresponds to obstacle 350. As a result, obstacle 350 indicated by detection result 340 is different from traffic light 320 indicated by reference information 330. Return to FIG. 7.

Obstacle specifying unit 50 checks information on the object included in detection result 340 to specify whether the object is identical to the object indicated by reference information 330. When the objects are identical to each other, deriving unit 40 and determination unit 42 perform the same processing as described above. On the other hand, when the objects are different from each other, obstacle specifying unit 50 specifies the presence of obstacle 350 and notifies deriving unit 40 of the presence of obstacle 350. Deriving unit 40 halts, upon being notified of the presence of obstacle 350 from obstacle specifying unit 50, the processing of decreasing the reliability. Accordingly, in determination unit 42, the occurrence of the failure of sensor 10 is not detected. That is, detector 34 disables, when detection result 340 acquired by first acquisition unit 30 indicates an object that is different from an object indicated by reference information 330 acquired by second acquisition unit 32, the detection of the occurrence of the failure of sensor 10.

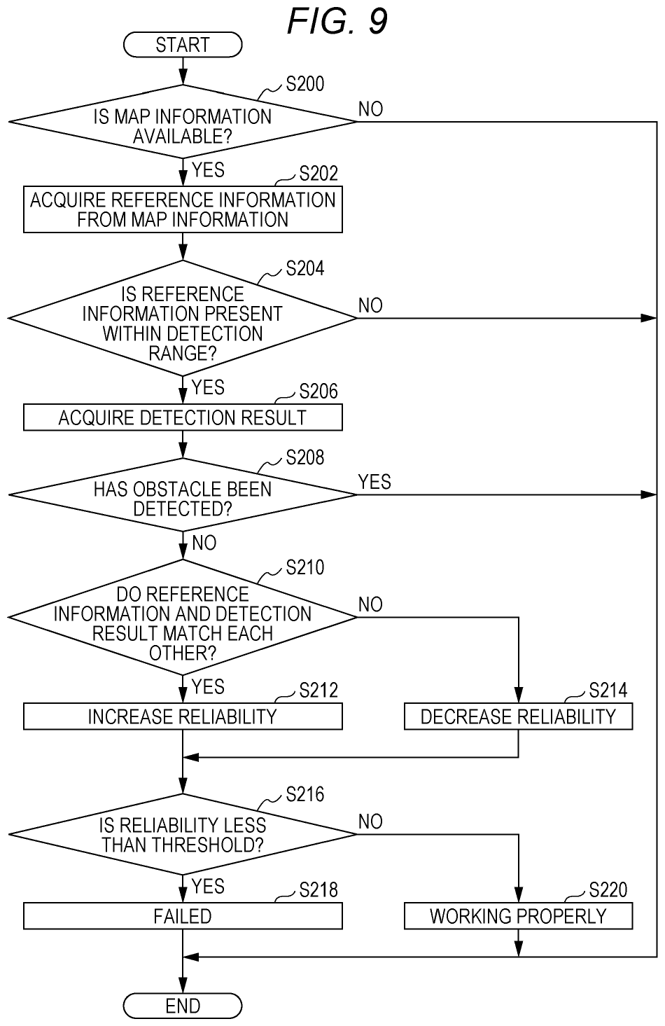

An operation of failure detection device 100 configured as described above will be described below. FIG. 9 is a flowchart showing a processing procedure of failure detection performed by failure detection device 100 according to the second exemplary embodiment of the present invention. Here, as an example, reference information 330 is acquired from storage unit 18, but it is also true for a case where reference information 330 is acquired from accumulation unit 16 or receiver 20. When the map information is available (Y in S200), second acquisition unit 32 acquires reference information 330 from the map information (S202). When reference information 330 is present within detection range 310 (Y in S204), first acquisition unit 30 acquires detection result 340 (S206).

When no obstacle has been detected (N in S208) and reference information 330 and detection result 340 match each other (Y in S210), deriving unit 40 increases the reliability (S212). When reference information 330 and detection result 340 do not match each other (N in S210), deriving unit 40 decreases the reliability (S214). When the reliability is less than the threshold (Y in S216), determination unit 42 determines that sensor 10 has failed (S218). When the reliability is not less than the threshold (N in S216), determination unit 42 determines that sensor 10 is working properly (S220). When the map information is not available (N in S200), reference information 330 is not present within detection range 310 (N in S204), or an obstacle has been detected (Y in S208), the processing is terminated.

In the operation of failure detection device 100 according to the second exemplary embodiment of the present invention, when the reliability derived is less than the predetermined threshold, the output circuit (notification unit 36) may output that sensor 10 has failed. In this configuration, the determination of the occurrence of the failure is made based on the reliability that is adjusted based on the comparison between the reference information and the detection result, which makes it possible to improve determination accuracy.

The output circuit (notification unit 36) may output not only that sensor 10 has failed but also the reliability. In this configuration, the reliability is notified, which makes the reliability available.

Deriving unit 40 of a controller (detector 34) may derive, based on the reference information, an anticipated detection result corresponding to detection anticipated to be made by sensor 10. The anticipated detection result corresponds to a detection result anticipated based on the reference information (in other words, a detection result predicted based on the reference information). Further, when similarity between the detection result of sensor 10 and the anticipated detection result is less than or equal to a predetermined value, the output circuit (notification unit 36) may output that sensor 10 has failed.

The predetermined value of the similarity is defined as a first predetermined value, and when the similarity between the detection result of sensor 10 and the anticipated detection result is less than or equal to a second predetermined value that is less than the first predetermined value and greater than a third predetermined value that is less than the second predetermined value, the output circuit (notification unit 36) may be prevented from outputting that sensor 10 has failed. In this configuration, a possibility of erroneously determining that the sensor has failed can be suppressed even when an object different from an object indicated by the reference information is indicated.

According to the present exemplary embodiment, when an obstacle is present between objects, the increase and decrease of the reliability is not performed, which makes it possible to reduce an influence of such an obstacle. Further, the possibility of erroneously determining that the sensor has failed can be suppressed even when an object different from an object indicated by the reference information is indicated.

The present invention has been described above based on the exemplary embodiments. It will be understood by those skilled in the art that the exemplary embodiments are merely examples, modifications in which components or processes of the exemplary embodiments are variously combined are possible, and these modifications still fall within the scope of the present invention.

An outline of an aspect of the present invention is as follows. An aspect of the present invention is a sensor failure detection device that is installable on a vehicle, and includes an input circuit and an output circuit. The input circuit is configured to connect with a sensor disposed on the vehicle and to receive reference information. When a predetermined relation is found between a detection result of the sensor and the reference information that have been input to the input circuit, the output circuit outputs that the sensor has failed.

According to this aspect, the occurrence of the failure is output based on the reference information and the detection result, which allows the occurrence of the failure to be easily detected for each sensor.

The sensor failure detection device may further include a control circuit. When the predetermined relation is found between the detection result of the sensor and the reference information that have been input to the input circuit, the control circuit performs control to cause the output circuit to output that the sensor has failed.

The control circuit may include a processor. The processor is caused to execute a predetermined program so that control is performed to cause the output circuit to output that the sensor has failed when the predetermined relation is found between the detection result of the sensor and the reference information that have been input to the input circuit.

The input circuit may include a first acquisition unit that receives the detection result of the sensor and the second acquisition unit that receives the reference information.

The output circuit may be configured to connect with an external autonomous driving control device.

The sensor may be at least one of the following (1) to (6):

(1) an image sensor of a camera device;

(2) a millimeter-wave radar;

(3) a light detection and ranging (LIDAR);

(4) a laser imaging detection and ranging (LIDAR);

(5) an ultrasonic sensor; and

(6) an infrared laser sensor.

The reference information may be included in map information. The sensor failure detection device may further include a storage unit that stores the map information. In this configuration, the reference information included in the map information is prestored, which facilitates the acquisition of the reference information.

The sensor failure detection device may further include a communication circuit configured to communicate with the outside. Further, the reference information may be input to the input circuit via the communication circuit. In this configuration, the reference information is acquired from a received signal, which makes it possible to deal with a case where reference information is updated.

The sensor failure detection device may further include an accumulation circuit that accumulates the detection result of the sensor previously acquired. The reference information may further include at least the detection result of the sensor previously acquired and accumulated in the accumulation circuit. In this configuration, the detection result previously acquired is used as the reference information, which eliminates the need for preparing the reference information.

Reliability of the sensor may be derived based on the detection result of the sensor and the reference information. Further, when the reliability thus derived is less than a predetermined threshold, the output circuit may output that the sensor has failed. In this configuration, the determination of the occurrence of the failure is made based on the reliability that is adjusted based on a comparison between the reference information and the detection result, which makes it possible to improve determination accuracy.

The output circuit may output not only that the sensor has failed but also the reliability. In this configuration, the reliability is notified, which makes the reliability available.

An anticipated detection result corresponding to detection anticipated to be made by the sensor may be derived based on the reference information. Further, when similarity between the detection result of the sensor and the anticipated detection result is less than or equal to a predetermined value, the output circuit may output that the sensor has failed.

The predetermined value of the similarity is defined as a first predetermined value, and when the similarity between the detection result of the sensor and the anticipated detection result is less than or equal to a second predetermined value that is less than the first predetermined value and greater than a third predetermined value that is less than the second predetermined value, the output circuit may be prevented from outputting that the sensor has failed. In this configuration, a possibility of erroneously determining that the sensor has failed can be suppressed even when an object different from an object indicated by the reference information is indicated.

Vehicle 200 according to the first and second exemplary embodiments performs autonomous driving. However, the present invention is not limited to the above, and, for example, vehicle 200 need not perform autonomous driving. In this configuration, vehicle 200 outputs a warning to a driver based on the detection result. This modification allows the range of application of failure detection device 100 to be expanded.

According to the first and second exemplary embodiments, second acquisition unit 32 acquires the reference information from each of accumulation unit 16, storage unit 18, and receiver 20. However, the present invention is not limited to this configuration, and, for example, second acquisition unit 32 may acquire the reference information from one or two of accumulation unit 16, storage unit 18, and receiver 20. This modification can facilitate the configuration.

According to the first and second exemplary embodiments, deriving unit 40 of detector 34 checks whether a range indicated by reference information 330 and a range indicated by detection result 340 match each other. At that time, a latitude and a longitude are used to specify the range. However, the present invention is not limited to this configuration, and, for example, an altitude may be used in addition to the latitude and the longitude. According to this modification, information on a height of an object is also used, which makes it possible to further improve detection accuracy.

### INDUSTRIAL APPLICABILITY

The present invention allows, even under a condition where a plurality of sensors are in use, the occurrence of the failure of each of the sensors to be easily detected; thus, the present invention is useful for a sensor failure detection device, a control method for the sensor failure detection device, and the like.

### REFERENCE MARKS IN THE DRAWINGS

10 sensor

12 positioning unit

14 sensor processor

16 accumulation unit (accumulation circuit)

18 storage unit

20 receiver (communication circuit)

22 autonomous driving controller

30 first acquisition unit

32 second acquisition unit

33 input circuit

34 detector (control circuit)

36 notification unit (output circuit)

40 deriving unit

42 determination unit

50 obstacle specifying unit

100 failure detection device (sensor failure detection circuit)

200 vehicle

300 road

310 detection range

320 traffic light

330 reference information

340 detection result

350 obstacle

1. A sensor failure detection device installable on a vehicle, the sensor failure detection device comprising:
an input circuit configured to connect with a sensor disposed on the vehicle and to receive reference information and location information on the vehicle; and
an output circuit,
wherein the reference information includes at least a type of an object, and location information indicating where the object is placed, and
when a predetermined relation is found among a detection result of the sensor, the reference information, and the location information that have been input to the input circuit, the output circuit outputs that the sensor has failed.

2. The sensor failure detection device according to claim 1, further comprising a control circuit,
wherein when the predetermined relation is found among the detection result of the sensor, the reference information, and the location information that have been input to the input circuit, the control circuit performs control to cause the output circuit to output that the sensor has failed.

3. The sensor failure detection device according to claim 2, wherein
the control circuit includes a processor, and
when the predetermined relation is found among the detection result of the sensor, the reference information, and the location information that have been input to the input circuit, the control circuit causes the processor to execute a predetermined program to perform control to cause the output circuit to output that the sensor has failed.

4. The sensor failure detection device according to claim 1, wherein the input circuit includes a first acquisition unit that receives the detection result of the sensor, and a second acquisition unit that receives the reference information and the location information.

5. The sensor failure detection device according to claim 1, wherein the output circuit is configured to connect with an external autonomous driving control device.

6. The sensor failure detection device according to claim 1, wherein the sensor is at least one of following (1) to (6):
(1) an image sensor of a camera device;
(2) a millimeter-wave radar;
(3) a light detection and ranging (LIDAR);
(4) a laser imaging detection and ranging (LIDAR);
(5) an ultrasonic sensor; and
(6) an infrared laser sensor.

7. (canceled)

8. The sensor failure detection device according to claim 1, further comprising a storage unit that stores the type of the object and the location information indicating where the object is placed.

9. The sensor failure detection device according to claim 1, wherein the input circuit is configured to connect with a positioning unit disposed on the vehicle and to receive the location information on the vehicle from the positioning unit.

10. The sensor failure detection device according to claim 1, further comprising a communication circuit configured to communicate with an outside,
wherein the reference information is input to the input circuit via the communication circuit.

11. The sensor failure detection device according to claim 1, further comprising an accumulation circuit that accumulates the detection result of the sensor previously acquired,
wherein the reference information includes at least the detection result of the sensor previously acquired and accumulated in the accumulation circuit.

12. The sensor failure detection device according to claim 1, wherein
reliability of the sensor is derived based on the detection result of the sensor and the reference information, and
when the reliability derived is less than a predetermined threshold, the output circuit outputs that the sensor has failed.

13. The sensor failure detection device according to claim 12, wherein the output circuit outputs not only that the sensor has failed but also the reliability.

14. The sensor failure detection device according to claim 1, wherein
an anticipated detection result corresponding to detection anticipated to be made by the sensor is derived based on the reference information, and
when similarity between the detection result of the sensor and the anticipated detection result is less than or equal to a predetermined value, the output circuit outputs that the sensor has failed.

15. The sensor failure detection device according to claim 14, wherein
the predetermined value of the similarity is defined as a first predetermined value, and
when the similarity between the detection result of the sensor and the anticipated detection result is less than or equal to a second predetermined value that is less than the first predetermined value and greater than a third predetermined value that is less than the second predetermined value, the output circuit does not output that the sensor has failed.

16. A control method for a sensor failure detection device including an input circuit configured to connect with a sensor disposed on a vehicle and to receive reference information and an output circuit, the reference information including at least a type of an object, and location information indicating where the object is placed, the control method comprising
outputting, by the output circuit, when a predetermined relation is found between a detection result of the sensor and the reference information that have been input to the input circuit, that the sensor has failed.
